(19) United States
(12) Patent Application Publication
(10) Pub. No.: US 2025/0073691 A1
(43) Pub. Date: Mar. 6, 2025

(54) THERMODYNAMIC-BASED METHODS FOR FORMATION OF PROMOTED METAL CATALYSTS

(71) Applicant: UNIVERSITY OF SOUTH CAROLINA, COLUMBIA, SC (US)

(72) Inventors: JOHN MONNIER, COLUMBIA, SC (US); JOHN MEYNARD TENGCO, COLUMBIA, SC (US); MASUDUR RAHMAN, KNOXVILLE, TN (US)

(21) Appl. No.: 18/748,743

(22) Filed: Jun. 20, 2024

Related U.S. Application Data
(60) Provisional application No. 63/579,142, filed on Aug. 28, 2023.

(51) Int. Cl. B01J 37/02; B01J 21/04; B01J 23/66; B01J 23/68; B01J 37/08

(52) U.S. Cl. CPC B01J 37/0201; B01J 21/04; B01J 23/66; B01J 23/688; B01J 37/088

(57) ABSTRACT

Methods are described for formation of a promoted catalysts. Promoted catalysts include metal oxide promoted silver catalysts for use in ethylene oxide production. Methods utilize a combination of relative surface free energies of catalyst and promoter materials, promoter loading concentrations, and calcination temperatures to encourage deposition and diffusion of promoters on catalyst metals of supported catalysts.

### CROSS REFERENCE TO RELATED APPLICATION

This application claims filing benefit of U.S. Provisional Patent Application Ser. No. 63/579,142 having a filing date of Aug. 28, 2023, entitled “Metal Oxide/Metal Catalysts Formed by Use of Differential Surface Free Energies,” which is incorporated herein by reference for all purposes.

### BACKGROUND

One of the biggest problems in manufacturing catalysts with multiple components is to locate all of the components in proximal position to one another so as to fully utilize the synergistic properties that result from cooperative interaction of the different components. For instance, ethylene oxide production uses silver (Ag) catalysts in conjunction with promoters that are added to improve reaction selectivity to ethylene oxide. Elements such as cesium (Cs), rhenium (Re), and molybdenum (Mo) have been shown to be effective promoters either alone or in various combinations with one another. Typical synthesis of promoted silver catalysts use simple impregnation of precursors into a support (e.g., alumina (α-Al₂O₃)) with no control for targeting the promoter element to be in a proximal, adjacent position relative to the Ag surface sites.

What is needed in the art are catalyst formation methods that can provide promoted catalysts with improved positioning of promoters relative to the catalytic metal. Resulting catalysts can exhibit improved activity as compared to previously known catalysts with randomly located materials.

### SUMMARY

According to one embodiment, disclosed are methods for forming promoted catalysts. A method can include combining a solution with a porous support material. The solution can include a catalyst metal and a metal oxide promoter. The metal oxide promoter can have a surface free energy of about 100 ergs/cm² or less, and the catalyst metal can have a surface free energy of about 1000 ergs/cm² or more. Upon the combination, the catalyst metal and the metal oxide promoter can be co-impregnated in the porous support material, with the impregnated porous support material comprising the metal oxide promoter at a concentration of about 1.2 micromoles per gram catalyst (μmol/g-cat) or greater. A method can also include a first calcination of the impregnated support material at a temperature of about 250° C. or greater and a second calcination step of the impregnated support material at a temperature that is higher than that of the first calcination step. The formation method can provide preferential deposition of the promoter on the catalyst metal and provide a promoted catalyst with improved activity.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 presents a hydrogen titration pulse chart for 12 wt. % Ag/α-Al₂O₃ particles.

FIG. 2 presents temperature programed reduction (left) and pulsed hydrogen titration at 170° C. (right) for 3 wt. % Cs/α-Al₂O₃ (top), 3 wt. % Re/α-Al₂O₃ (middle) and 4 wt. % Mo/α-Al₂O₃ (bottom).

FIG. 3 presents the fractional coverages of Cs on Ag and α-Al₂O₃ as a function of promoter levels.

FIG. 4 presents hydrogen uptake plotted against μmol promoter loading on 12 wt. % Ag/α-Al₂O₃.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

The technology described in this disclosure uses thermodynamics, one of the basic forces of science and nature, to drive the formation of multi-component catalysts with key components in the correct positions. More specifically, disclosed methods utilize a combination of relative surface free energies of catalyst and promoter materials, promoter loading concentrations, and calcination temperatures to encourage deposition of promoters at preferred locations on the catalyst materials, and in particular, to encourage thermodynamically preferential diffusion of promoters on catalyst metals. This disclosed approach can form a superior catalyst compared to currently known catalysts.

In one embodiment, disclosed formation methods and catalysts formed thereby can improve the selectivity to form ethylene oxide relative to formation of CO₂, a greenhouse gas. Thus, in addition to using the expensive ethylene feed gas more efficiently, disclosed methods and catalysts can lower greenhouse gas emissions.

Disclosed methods take advantage of surface free energy differences between catalyst metals and metal oxide promoters to preferentially locate a promoter in proximity to the catalyst metal sites, thereby creating truly promoted catalysts. At relatively high loading level for the promoter metal oxide (e.g., about 1.2 μmol/g-cat or greater) and upon thermal treatment of the promoted catalysts, disclosed systems with a relatively large differential in surface free energies between the catalyst and promoter metal oxide can reconfigure to form a lower overall surface free energy—i.e. the metal oxide with a relatively low surface free energy can preferentially migrate toward the surface of the catalyst metal with the relatively high surface free energy, and upon calcination, the promoters can readily diffuse onto the surface of the catalyst metal.

According to the present disclosure, a formation method can include forming a solution that includes a catalytic metal and a metal oxide promoter. In general, a solution formation process can include dissolving salts of the catalytic metal and the metal oxide in a suitable solvent in addition to any other components that may be of benefit to an impregnation process or the formed supported catalyst material.

The catalyst metal is not particularly limited, and can encompass any catalytic metal having a surface free energy of about 1000 ergs/cm² or greater, such as from about 1000 ergs/cm² to about 4000 ergs/cm², from about 1000 ergs/cm² to about 3000 ergs/cm², or from about 1000 ergs/cm² to about 2000 ergs/cm² in one embodiment. Table 1, below, provides surface free energies and melting point values of several exemplary metals.

TABLE 1

| | Melting point | Surface free energy |
|---|---|---|
| Metal | (° C.) | (ergs/cm² surface) |
| Silver (Ag) | 962 | 1302 |
| Gold (Au) | 1064 | 1626 |
| Copper (Cu) | 1083 | 1934 |
| Palladium (Pd) | 1554 | 2043 |
| Nickel (Ni) | 1453 | 2364 |
| Platinum (P)t | 1772 | 2691 |
| Cobalt (Co) | 1495 | 2709 |
| Rhodium (Rh) | 1966 | 2828 |
| Molybdenum (Mo) | 2617 | 2877 |
| Iron (Fe) | 1535 | 2939 |
| Niobium (Nb) | 2468 | 2983 |
| Rhenium (Re) | 3180 | 3109 |
| Iridium (Ir) | 2410 | 3231 |
| Ruthenium (Ru) | 2310 | 3409 |
| Tungsten (W) | 3410 | 3468 |

In one embodiment, the catalyst metal can be a Group IB metal, e.g., silver, gold, copper, or any combination thereof.

A solution can include a salt of the catalytic metal, e.g., a nitrate, oxalate, or carbonate salt of a catalyst metal, optionally with suitable solubilizing or reducing agents as known in the art, e.g., an alkanolamine, alkyldiamine, ammonia, or any combination thereof. In one embodiment, a method can include formation of an aqueous solution containing a metal salt of a carboxylic acid and an organic amine. By way of example, a silver oxide slurry in water can be combined with a mixture of ethylene diamine and oxalic acid to form an aqueous solution of silver oxalate-ethylene diamine-complex, to which solution can be added one or more promoter compounds as described further herein. Other amines, such as ethanolamine, may be included as well.

The solution can also include one or more promoter compounds, at least one of which can be a metal oxide promoter. In one embodiment, a solution can include a metal oxide salt containing a high valent oxyanion promoter such as, and without limitation to, a high valent rhenium oxide, molybdenum oxide, tungsten oxide, sulfur oxide, or any combination thereof. For instance, a metal oxide promoter can include ReO₄⁻, MoO₄²⁻, WO²⁻, SO₄²⁻, and the like, or any combination thereof. The metal oxide can be of any form, provided the metal oxide has a surface free energy as described herein. By way of example, and without limitation, a solution can include a rhenium oxide promoter such as rhenium sesquioxide (Re₂O₃), rhenium dioxide (ReO₂), rhenium trioxide (ReO₃), perrhenate (ReO₄), rhenium heptoxide (Re₂O₇⁻), or any combination thereof.

The metal oxide promoter can have a surface free energy of about 100 ergs/cm² or less. For instance, exemplary promoter metal oxide rhenium heptoxide has a surface free energy of about 38 ergs/cm², molybdenum trioxide (MoO₃) has a surface free energy of about 97 ergs/cm², and phosphorous pentoxide (P₂O₅) has a surface free energy of about 55 ergs/cm², any one or combination of which can be preferentially deposited on a supported catalytic metal according to disclosed methods.

The solution can contain the metal oxide promoter in an amount such that the loading level of the metal oxide promoter on the porous support is about 1.2 μmol/g-cat or greater, such as from about 1.2 μmol/g-cat to about 3 μmol/g-cat in some embodiments.

In addition to one or more catalyst metals and metal oxide promoters, a solution can include one or more additional promoters as are known in the art. By way of example, a solution can include an alkali metal or alkaline earth metal salt or hydroxide promoter such as a lithium, potassium, rubidium, cesium, beryllium, magnesium, calcium, strontium or barium salt or hydroxide, or any combination thereof as is generally known in the art. By way of example, a solution can include an alkali metal and/or alkaline earth metal nitrate or halide salt as an additional promoter.

When present, the solution can contain one or more additional promoters in an amount such that the loading level of the additional promoter on the porous support material is about 2 μmol/g-cat or greater, such as from about 2 μmol/g-cat to about 10 μmol/g-cat in some embodiments.

A solution can be combined with a porous catalyst support under conditions to encourage co-impregnation of the support by the catalyst metal and the promoter metal oxide (as well as any additional promoter materials, as desired) as is generally known in the art.

The porous catalyst support material can be any conventional porous support material that can function as a carrier for the active catalytic metals and promoters and any optional additives as desired. Suitable supports include, without limitation, alumina, silica, silica-aluminas, aluminosilicates, zirconia, titania, and the like. In one embodiment, a catalyst support material can include a transitional alumina, examples of which include gamma, delta, theta, and eta alumina, as well as any mixtures thereof. Mixtures of a transitional alumina with alpha alumina can also be utilized. In some embodiments, a catalyst support material can include a mixture of alumina with other support materials, such as silica, in any suitable combination.

In one embodiment, the support material can have a surface free energy that is between that of the catalyst metal and that of the metal oxide promoter, such as from about 100 ergs/cm² to about 1000 ergs/cm² in some embodiments. By way of example, Table 2, below, provides surface free energies and melting points of some exemplary porous support materials.

TABLE 2

| | Melting point | Surface Free Energy |
|---|---|---|
| Support material | (° C.) | (ergs/cm² surface) |
| Carbon | 3550 | 506 |
| Silica (SiO₂) | 1600 | 605 |
| Titania (TiO₂) | 1843 | 670 |
| Alumina (Al₂O₃) | 2072 | 805 |

Following co-impregnation of the porous support material with the catalyst metal and the metal oxide promoter, the impregnated support material can be calcinated at a temperature of about 250° C. or greater, followed by a second calcination step of the impregnated carrier at a temperature that is higher than that of the first calcination step. By way of example, a first calcination step can include calcination of the impregnated porous support material in air (e.g., a flowing air stream, in one embodiment) at a temperature of about 250° C. or higher, such as from about 250° C. to about 300° C., or from about 260° C. to about 280° C. in one embodiment.

Following, the impregnated porous support materials can be calcinated a second time at a temperature that is higher than that of the first calcination. For instance, the materials can be calcinated a second time in air at a temperature of about 270° C. or higher, such as from about 275° C. to about 320° C. in one embodiment.

Through utilization of the metal oxide promoter with a relatively low surface energy at a relatively high loading level and the two step calcination process, the metal oxide promoter can be preferentially positioned on the supported catalyst metal, thereby providing a truly promoted catalyst with improved activity as compared to promoted catalysts in which the promoter is randomly distributed over the catalyst and support materials.

The present invention may be better understood by reference to the Example provided below.

### Example

Catalysts were prepared by co-impregnation. Ag₂C₂O₄ was dissolved in an aqueous ethylenediamine (EN) (Millipore Sigma, ≥99%) solution using a 3:1 ratio for EN:Ag₂C₂O₄. The impregnation solution was prepared using 5% excess pore volume of the carrier (Saint Gobain SA5562 α-Al₂O₃, 8-mm rings, BET Surface area 0.73 m²/g by Kr BET, with water accessible pore volume of 0.32 cm³/g support). Promoter salts were added using co-impregnation of NH₄ReO₄ (Millipore Sigma, ≥99%), CsNO₃ (Millipore Sigma, 99.99% trace metal basis) and (NH₄)₂MO₄ (Millipore Sigma, 99.98% trace metal basis) dissolved at the same time with Ag₂C₂O₄ in ethylenediamine solution. The rings were tumble-dried in a 250 ml round bottom flask at 200 torr pressure and 60° C. until free tumbling rings were produced. Following impregnation, 25 g portions were calcined in fast flowing air (5 L/min) at 260° C. for 6 min.

α-Al₂O₃ samples containing Cs, Re, or Mo, but no Ag, were impregnated using an aqueous solution at 5% excess pore volume. These samples were tumbled dried in vacuum and fast calcined using the same parameters noted for Ag containing samples.

Prior to analysis, all samples were calcined ex situ at 280° C. in flowing air for 4 hrs to remove residual ethylenediamine. Unless specified otherwise, each experiment used 2.0 g of ground and sieved particles of 400-841 μm that were loaded into a Micromeritics Autochem™ 2920 equipped with a thermal conductivity detector and reduced in situ in flowing 10% H₂ balanced helium (bal He) at 280° C. for 2 hrs. Following reduction, samples were cooled to 170° C. in flowing 10% H₂ bal He, purged with He for 30 min, and exposed to 10% O₂ bal He for an additional 30 min to dissociatively adsorb molecular oxygen. The sample chamber was then flushed with He for 30 min and pulses of 10% H₂/balance Ar were passed over the sample at 170° C. and atmospheric pressure. The oxygen pre-coverage and hydrogen titration steps were repeated in situ 2 more times and reported as an average. Good agreement was observed between all titration experiments. For the unpromoted 12 wt. % Ag/α-Al₂O₃ sample, H₂ uptake was measured for three different samples; each sample was analyzed three times to give a total of nine H₂ titrations. This was done to determine reproducibility and obtain accurate values for the base sample.

Temperature programmed desorption (TPD) was performed using a high wattage, split-tube furnace (ATS) connected to an Inficon Transpector 2™ Mass Spectrometer and a manifold of Brooks™ 5850E mass flow controllers. Following the calcination at 260° C., 0.5 g of material was loaded into a ¼-inch quartz tube supported on a quartz plug and heated to 500° C. at 10° C./min ramp rate in 20 sccm flowing Ar while monitoring m/e=1-50, particularly for ethylenediamine which has a base peak at m/e=30. Temperature programmed reduction (TPR) was performed in the same Micromeritics Autochem™ 2920 described above using 2.0 g of “fresh” material ex situ calcined at 260° C. with flowing air. The sample was reduced in situ at 280° C. for 2 hrs in 20 sccm H₂, cooled to 170° C. in 20 sccm Ar and then O₂ exposure was performed for 30 min in 20 sccm of flowing 10% O₂ bal He. The catalyst was then cooled to 40° C. in 20 sccm of Ar and the feed was switched to 20 sccm 10% H₂ bal Ar before TPR was performed up to 500° C. at a ramp rate of 20° C./min.

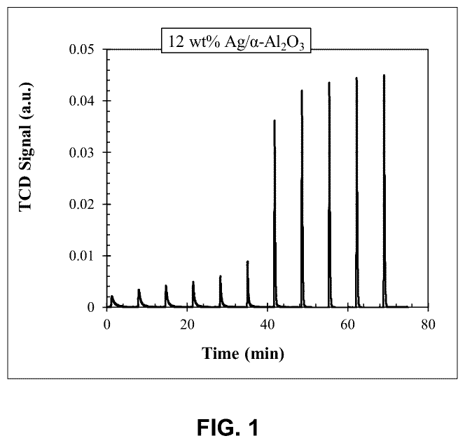

Following pretreatment, the reproducibility of H₂ uptake on unpromoted 12 wt. % Ag/α-Al₂O₃ was tested by twice repeating a series of pulsed titration experiments. In each case 2.0 g of fresh material supported on a bed of quartz wool was loaded into a quartz U-tube and samples were reduced in situ at 280° C. using 10% H₂/bal Ar. All samples were then purged with Ar at 280° C. for two hours, and then cooled to 170° C. where dissociative O₂ adsorption occurred; after a second purge in flowing Ar, pulsed H₂ titration was done. The pulsed hydrogen titration results are shown in FIG. 1 for the different 2.0 g samples. The calculated standard deviation of H₂ uptake was +0.004 cm³ H₂/g-sample, indicating a stable Ag surface with reproducible H₂ uptakes.

The Ag active site concentration determined by H₂ titration was 2.3×10¹⁸/g cat, which is approximately half as much as the value of 4.2×10¹⁸/g cat determined by counting and measuring particles from SEM images. This has been commonly observed when comparing chemisorption-derived active site concentrations, which are actually measured by molecules of gas uptake, with methods where active site concentrations are determined by inference (XRD line broadening, electron microscopies, XPS, etc.). The shortcomings of using electron microscopy as the basis for determining surface site concentrations include differences of particle shapes, insufficient number of particles counted, loss of surfaces due to conjoined particle faces, failure to be either spherical (sitting above the surface) or hemispherical, or assumptions that the metal particles are pristine with no surface contamination. For Ag particles such as those used for olefin epoxidation, the particles are far too large to use X-ray line broadening since the X-ray peaks are extremely sharp. It has been previously concluded that chemisorption and electrochemical surface area measurements, which count molecules and electrons, respectively, are superior to either x-ray line broadening or electron microscopy. Thus, 2.3×10¹⁸/g cat was used as the concentration of accessible Ag sites. For 12 wt. % Ag/α-Al₂O₃, this corresponds to an Ag dispersion of 0.0034.

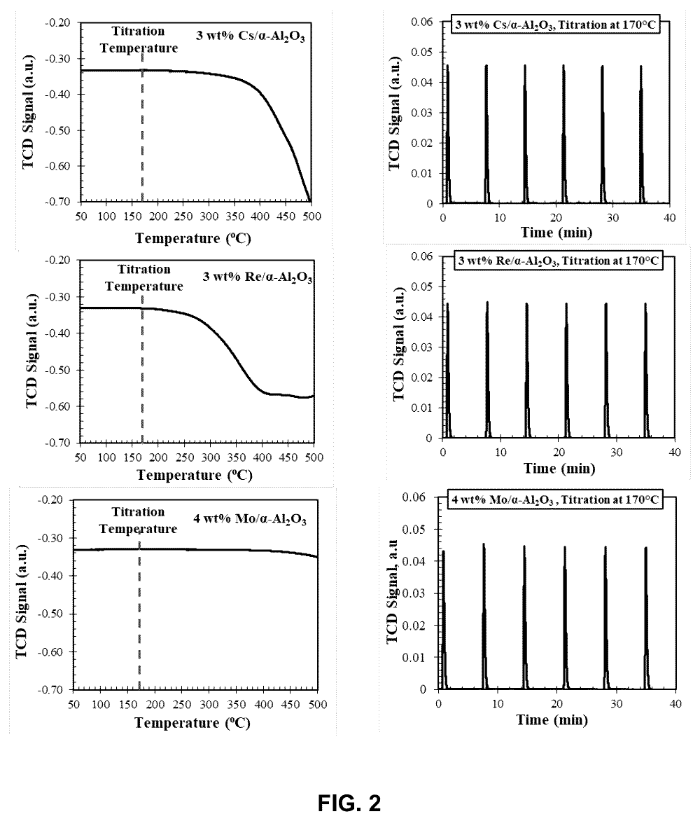

In order to determine reaction, or titration, trends of the promoters in the absence of Ag, a series of experiments using α-Al₂O₃ promoted with higher loadings of NH₄ReO₄, CsNO₃, or (NH₄)₂MoO₄ than traditionally used for authentic ethylene oxide catalysts were conducted to determine whether H₂ adsorption or promoter reduction might occur to give hydrogen consumption during H₂ titration of the O-covered Ag surface at 170° C. Higher promoter loadings were used to ensure observation of reduction events. Temperature programmed adsorption (TPR) of H₂ was performed from 50° C. to 500° C. following dissociative oxygen adsorption at 170° C. (TPR parameters: 50-500° C., 20 sccm 10% H₂ bal Ar, ramp rate: 20° C./min). Results are shown in FIG. 2 (left hand side). As indicated, the 3 wt. % Cs sample showed no H₂ uptake below 350° C., only minor uptake between 350° C. and 400° C., and significant uptake above 400° C. Given the extremely low ionization potential of Cs⁰, it is difficult to rationalize reduction of Cs⁺ at these conditions. The 3 wt. % Re/α-Al₂O₃ sample followed a similar trend although H₂ consumption began at a lower temperature of 275° C. with minor consumption occurring between 250° C. and 300° C. and substantial consumption between 300° C. and 400° C. with continued uptake to 500° C. 4 wt. % Mo/α-Al₂O₃ showed no signs of hydrogen uptake until 425° C. To confirm the absence of H₂ consumption at 170° C., fresh samples of each catalyst were subjected to a series of 10% H₂/balance Ar pulses and results are shown on the right hand side of FIG. 2. These experiments confirmed that the oxides of Cs, Re, and Mo do not undergo reduction at the temperature of 170° C. used for Ag—O titration and also that they should be stable at temperatures up to at least 270° C.

The randomness of coverage of Cs on Ag was determined using the decrease in Ag site concentration from H₂ titration data and the coverage of Cs on α-Al₂O₃, which was estimated from the exposed surface of α-Al₂O₃ after allowance was made for the fraction of surface covered by the interface of Ag particles as well as an assumption that Cs is deposited in a monodisperse, single layer coverage on both surfaces. The value of fraction of α-Al₂O₃ surface covered by Ag particles was determined using the particle size distribution of Ag, which was in turn determined by manually measuring 980 Ag particles in SEM micrographs. This approach was likely an oversimplification, but it does represent the most efficient use of Cs and provide a method for calculation.

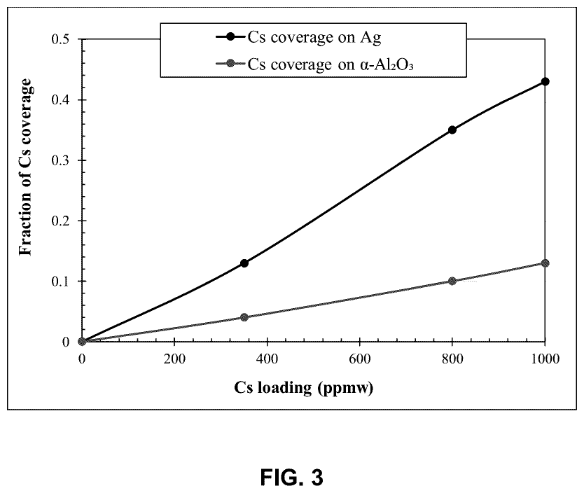

For a non-interactive support such as low surface area α-Al₂O₃, the value of 1.2×10¹⁹/m² surface was used to represent the number of potential Cs adsorption sites on α-Al₂O₃. The exposed α-Al₂O₃ surface was estimated to be lowered from 0.73 to 0.53 m²/g after Ag coverage of the support, corresponding to a 27% coverage by Ag. Using the decrease in Ag site concentration from H₂ titration data, the amount of Cs coverage of the Ag could be estimated. The amount of Cs available for the α-Al₂O₃ surface was thus the nominal promoter loading minus the amount on Ag. The plot of FIG. 3 shows the resulting partitioning of Cs between Ag and α-Al₂O₃ as a function of Cs loading in ppmw. The linear dependency of Cs deposition on both surfaces shows clearly that Cs placement was random on both surfaces and not targeted to either surface.

Catalysts were also formed including a fixed Cs concentration of 350 ppmw (2.6 μmol/g-cat) and Re loadings varied between 150 and 500 ppmw (0.8 and 2.7 μmol/g-cat, respectively). Samples are described in Table 3, below.

TABLE 3

| | Promoters | | |
|---|---|---|---|
| | (μmol/g-cat) | | |
| Sample | Cs | Re | Total |
| A | — | — | — |
| B | 2.6 | — | 2.6 |
| C | 6.0 | — | 6.0 |
| D | 7.5 | — | 7.5 |
| E | 2.6 | 0.8 | 3.4 |
| F | 2.6 | 1.1 | 3.7 |
| G | 2.6 | 1.3 | 4.0 |
| H | 2.6 | 1.6 | 4.2 |
| I | 2.6 | 2.7 | 5.3 |

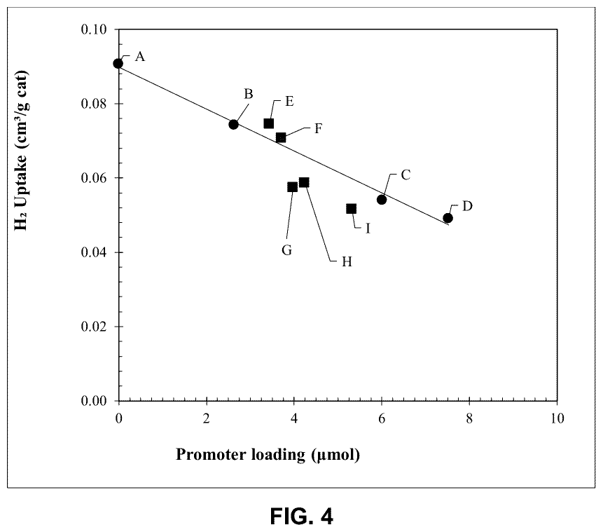

H₂ titrations as described previously were then carried out to determine the effect of Re loading on the samples. Results are shown in FIG. 4. As indicated, both the Cs-promoted samples and the Cs—Re samples followed a linear decrease in H₂ consumption for the lower concentrations of Re (points E and F), indicating random distribution on both Ag and α-Al₂O₃. The Cs+Re points fit on the linear Cs connecting line (points A-D). However, for the higher Re loadings (points G, H, I), the H₂ uptake values fell below the Cs line, suggesting targeting of Re on the Ag particle.

It is believed that this is due to the lower surface free energy of Re₂O₇ (or ReO₄⁻ salts) compared to Ag⁰ and α-Al₂O₃. Surface free energies at 200° C. are approximately 1320, 805, and 29 ergs/cm², for Ag⁰, α-Al₂O₃, and Re₂O₇, respectively. All high valent Re salts have exceptionally low surface energies, indicating high mobilities and as a result, for the Ag—ReOₓ—Al₂O₃ system, the ReOₓ will be thermodynamically driven to diffuse onto the Ag surface to lower the SFE of Ag.

While certain embodiments of the disclosed subject matter have been described using specific terms, such description is for illustrative purposes only, and it is to be understood that changes and variations may be made without departing from the spirit or scope of the subject matter.

What is claimed is:

1. A method for forming a promoted catalyst comprising:
combining a solution with a porous support material, the solution comprising a catalyst metal and a metal oxide promoter, the metal oxide promoter having a surface free energy of about 100 ergs/cm² or less, the catalyst metal having a surface free energy of about 1000 ergs/cm² or more, wherein upon the combination, the catalyst metal and the metal oxide promoter are co-impregnated in the porous support material, the impregnated porous support material comprising the metal oxide promoter in a concentration of about 1.2 μmol per gram catalyst or greater;
calcinating the impregnated support material in a first calcination at a temperature of about 250° C. or greater; and
calcinating the impregnated support material in a second calcination at a temperature that is greater than the temperature of the first calcination.

2. The method of claim 1, wherein the catalyst metal comprises a Group IB metal.

3. The method of claim 1, wherein the catalyst metal comprises silver.

4. The method of claim 1, wherein the metal oxide promoter comprises a rhenium oxide, a molybdenum oxide, a tungsten oxide, a sulfur oxide, or any combination thereof.

5. The method of claim 4, wherein the metal oxide promoter comprises ReO₄⁻, MoO₄²⁻, WO²⁻, SO₄²⁻, or any combination thereof.

6. The method of claim 4, wherein the metal oxide promoter comprises as rhenium sesquioxide, rhenium dioxide, rhenium trioxide, perrhenate, rhenium heptoxide, or any combination thereof.

7. The method of claim 1, the solution further comprising an alkali metal salt or hydroxide, an alkaline earth metal salt or hydroxide, or any combination thereof.

8. The method of claim 7, wherein the alkali metal salt or alkaline earth metal salt comprises a nitrate salt or a halide salt.

9. The method of claim 7, the impregnated porous support material comprising the alkali metal salt or hydroxide or the alkaline earth metal salt or hydroxide in a concentration of about 2 μmol/g-cat or greater.

10. The method of claim 1, the porous support material comprising an alumina, a silica, an aluminosilicate, a zirconia, a titania, or any combination thereof.

11. The method of claim 1, wherein the porous support material has a surface free energy that is between the surface free energy of the catalyst metal and the surface free energy of the metal oxide promoter.

12. The method of claim 1, wherein the second calcination is at a temperature of from about 270° C. or higher.

13. The method of claim 1, wherein the second calcination is at a temperature of from about 275° C. to about 300° C.
